(19) United States
(12) Patent Application Publication
(10) Pub. No.: US 2018/0167984 A1
(43) Pub. Date: Jun. 14, 2018

(54) ACHIEVING BETTER PERFORMANCE IN L + L MODEMS

(71) Applicant: QUALCOMM Incorporated, San Diego, CA (US)

(72) Inventors: Parthasarathy KRISHNAMOORTHY, San Diego, CA (US); Ammar KITABI, San Diego, CA (US); Jayesh BATHIJA, San Diego, CA (US); Praveen Kumar APPANI, San Diego, CA (US); Prashanth MOHAN, Chennai (IN); Muthukumaran DHANAPAL, San Diego, CA (US); Shravan Kumar RAGHUNATHAN, San Diego, CA (US); Vijay MARWAH, San Diego, CA (US); Hargovind Prasad BANSAL, Hyderabad (IN); Sagar Bharatkumar SHAH, San Diego, CA (US); Raevanth Venkat ANNAM, Tuticorin (IN); Naveen Kumar PASUNOORU, Hyderabad (IN); Vasanth Kumar RAMKUMAR, San Diego, CA (US)

(21) Appl. No.: 15/378,429

(22) Filed: Dec. 14, 2016

(51) Int. Cl. H04W 76/02; H04B 1/3816; H04W 76/06; H04W 48/10

(52) U.S. Cl. CPC H04W 76/028; H04B 1/3816; H04W 88/06; H04W 48/10; H04W 76/066; H04W 76/068

(57) ABSTRACT

A method for reestablishing a radio resource control (RRC) connection on a second subscription upon completion of a voice call on a first subscription for a multi-subscriber identity module (SIM) multi-standby (MSMS) mobile communication device, includes: starting a voice call timer at the start of the voice call on the first subscription; stopping the voice call timer upon completion of the voice call on the first subscription; determining an elapsed time of the voice call on the first subscription based on a value of the voice call timer; and determining whether the elapsed time of the voice call on the first subscription is greater than a value of a network connectivity timer.

In a long term evolution (LTE)+LTE or LTE+X, where X is another radio access technology (RAT) (e.g., global system for mobile communication (GSM), wideband code division multiple access (WCDMA), code division multiple access (CDMA), etc.) modem (i.e., a single transceiver device) for a multi-subscriber identity module (SIM) multi-standby mobile communication device, whenever a first subscription enters a voice over long term evolution (VoLTE) or circuit-switched (CS) voice call, a second subscription may declare a radio link failure (RLF) and initiate RLF recovery procedures once the VoLTE/Voice call is completed on the first subscription. Attempting the RLF recovery procedure on the second subscription each time a voice call ends on the first subscription is inefficient in the LTE+LTE/LTE+X multi-SIM modem since the procedure will fail if the elapsed time of the voice call is long enough such that the communication network no longer maintains the mobility management entity (MME) context for the second subscription.

Conventional algorithms do not consider the network inactivity (i.e., MME context) timer and whether both subscriptions are associated with a communication network operated by a same operator (or roaming partners of the operator) or whether the subscriptions are associated with communication networks operated by different operators.

### SUMMARY

Apparatuses and methods for reestablishing an RRC connection on a second subscription after a voice call on a first subscription for an MSMS mobile communication device are provided.

According to various aspects there is provided a method for reestablishing a radio resource control (RRC) connection on a second subscription upon completion of a voice call on a first subscription for a multi-subscriber identity module (SIM) multi-standby (MSMS) mobile communication device. In some aspects, the method may include: starting a voice call timer at the start of the voice call on the first subscription; stopping the voice call timer upon completion of the voice call on the first subscription; determining an elapsed time of the voice call on the first subscription based on a value of the voice call timer; and determining whether the elapsed time of the voice call on the first subscription is greater than a value of a network connectivity timer.

According to various aspects there is provided a multi-subscriber identity module (SIM) multi-standby (MSMS) mobile communication device. In some aspects, the MSMS mobile communication device may include: a communication unit configured to communicate with one or more communication networks; a memory operably connected to the communication unit; a timing unit configured to implement one or more timers; and a control unit operably connected to the communication unit, the memory, and the timing unit.

The control unit may be configured to: control the timing unit to start a voice call timer at the start of a voice call on a first subscription; control the timing unit to stop the voice call timer upon completion of the voice call on the first subscription; determine an elapsed time of the voice call on the first subscription based on a value of the voice call timer; and determine whether the elapsed time of the voice call on the first subscription is greater than a value of a network connectivity timer.

According to various aspects there is provided a non-transitory computer readable medium. In some aspects, the non-transitory computer readable medium may include instructions for causing one or more processors to perform operations including: starting a voice call timer at the start of the voice call on the first subscription; stopping the voice call timer upon completion of the voice call on the first subscription; determining an elapsed time of the voice call on the first subscription based on a value of the voice call timer; and determining whether the elapsed time of the voice call on the first subscription is greater than a value of a network connectivity timer.

According to various aspects there is provided a multi-subscriber identity module (SIM) multi-standby (MSMS) mobile communication device. In some aspects, the MSMS mobile communication device may include: means for starting a voice call timer at the start of a voice call on a first subscription; means for stopping the voice call timer upon completion of the voice call on the first subscription; means for determining an elapsed time of the voice call on the first subscription based on a value of the voice call timer; and means for determining whether the elapsed time of the voice call on the first subscription is greater than a value of a network connectivity timer.

Other features and advantages should be apparent from the following description which illustrates by way of example aspects of the various teachings of the disclosure.

### BRIEF DESCRIPTION OF THE DRAWINGS

Aspects and features of the various embodiments will be more apparent by describing examples with reference to the accompanying drawings, in which:

FIG. 1A is a block diagram illustrating a mobile communication device according to various embodiments;

FIG. 1B is a diagram illustrating a network environment for various embodiments;

FIG. 2 is a flowchart illustrating a method for reestablishing an RRC connection on a second subscription after a voice call on a first subscription for an MSMS mobile communication device;

FIG. 3 is a flowchart illustrating a method for estimating the value of the inactivity time in accordance with various aspects of the present disclosure; and

FIG. 4 is a flowchart illustrating a method for performing an RRC connection release procedure in accordance with various aspects of the present disclosure.

### DETAILED DESCRIPTION

While certain embodiments are described, these embodiments are presented by way of example only, and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection.

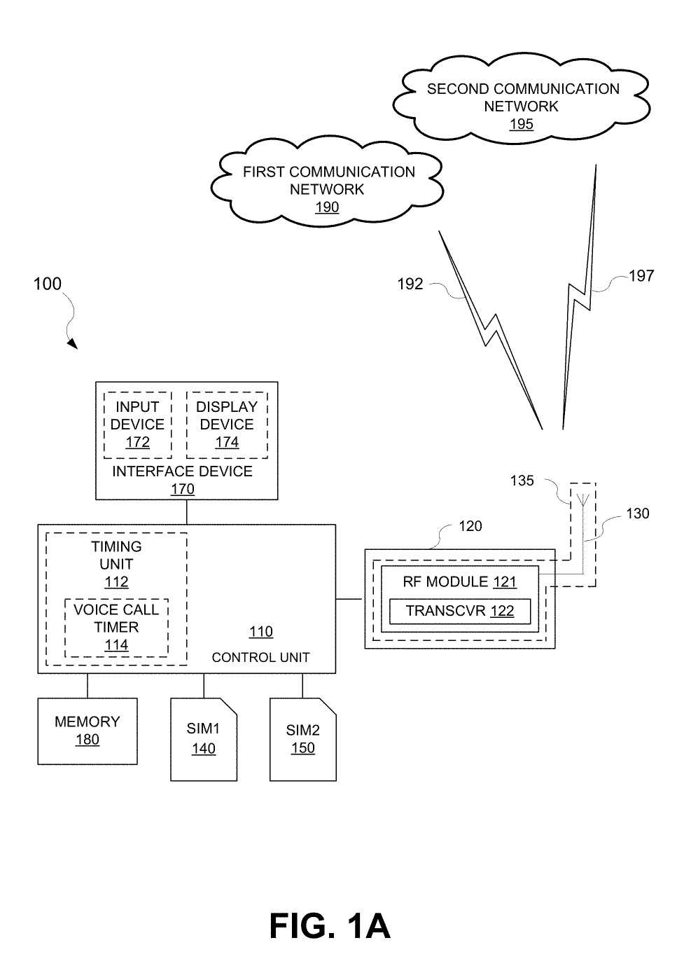

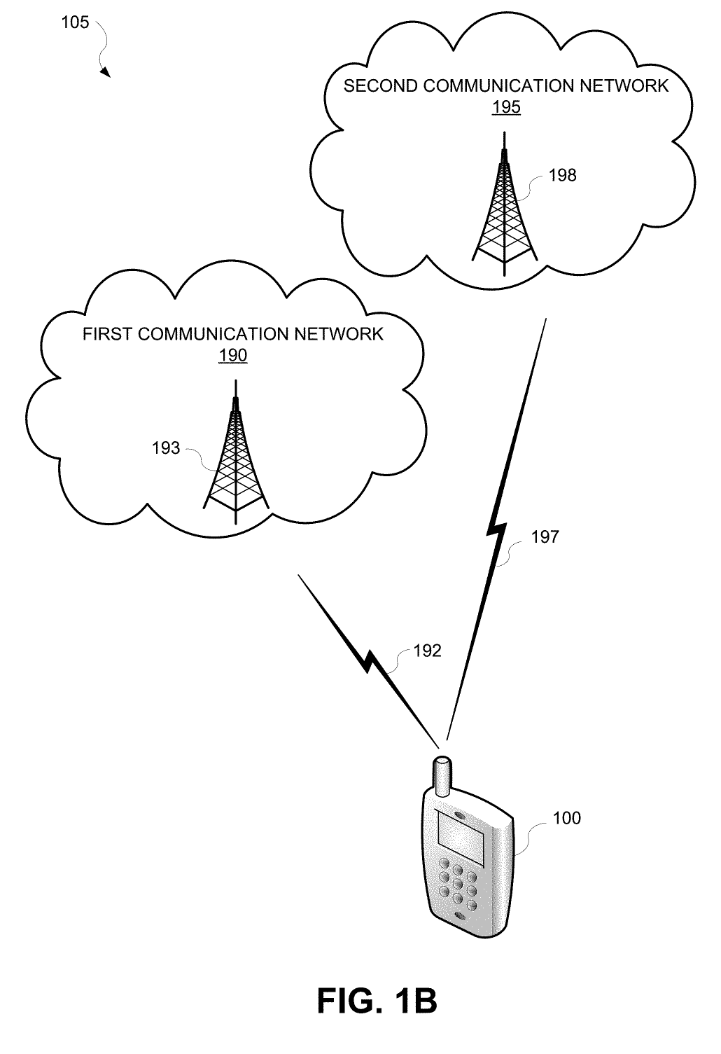

FIG. 1A is a block diagram illustrating a mobile communication device 100 according to various embodiments. As illustrated in FIG. 1A, the mobile communication device 100 may include a control unit 110, a communication unit 120, an antenna 130, a first subscriber identity module (SIM) 140, a second SIM 150, a user interface device 170, and a memory 180.

The mobile communication device 100 may be, for example but not limited to, a mobile telephone, smartphone, tablet, computer, etc., capable of communications with one or more wireless networks. One of ordinary skill in the art will appreciate that the mobile communication device 100 may include one or more communication units and may interface with one or more antennas without departing from the scope of protection.

The communication unit 120 may include, for example, but not limited to, a radio frequency (RF) module 121. The RF module 121 may include, for example, but not limited to a transceiver 122. An RF chain 135 may include, for example, but not limited to the antenna 130 and the RF module 121.

One of ordinary skill in the art will appreciate that embodiments of the mobile communication device 100 may include more than one communication unit and/or more than one antenna without departing from the scope of protection.

A SIM (for example the first SIM 140 and/or the second SIM 150) in various embodiments may be a universal integrated circuit card (UICC) that is configured with SIM and/or universal SIM (USIM) applications, enabling access to global system for mobile communications (GSM) and/or universal mobile telecommunications system (UMTS) networks. The UICC may also provide storage for a phone book and other applications. Alternatively, in a code division multiple access (CDMA) network, a SIM may be a UICC removable user identity module (R-UIM) or a CDMA subscriber identity module (CSIM) on a card. A SIM card may have a CPU, ROM, RAM, EEPROM and I/O circuits. An integrated circuit card identity (ICCID) SIM serial number may be printed on the SIM card for identification. However, a SIM may be implemented within a portion of memory of the mobile communication device 100, and thus need not be a separate or removable circuit, chip, or card.

A SIM used in various embodiments may store user account information, an international mobile subscriber identity (IMSI), a set of SIM application toolkit (SAT) commands, and other network provisioning information, as well as provide storage space for phone book database of the user's contacts. As part of the network provisioning information, a SIM may store home identifiers (e.g., a system identification number (SID)/network identification number (NID) pair, a home public land mobile network (HPLMN) code, etc.) to indicate the SIM card network operator provider.

The first SIM 140 may associate the communication unit 120 with a first subscription (Sub1) 192 associated with a first radio access technology (RAT) on a first communication network 190 and the second SIM 150 may associate the communication unit 120 with a second subscription (Sub2) 197 associated with a second RAT on a second communication network 195. When a RAT is active, the communication unit 120 may receive and transmit signals on the active RAT. When a RAT is idle, the communication unit 120 may receive but not transmit signals on the idle RAT.

For convenience, the various embodiments are described in terms of dual-SIM dual-standby (DSDS) mobile communication devices. However, one of ordinary skill in the art will appreciate that the various embodiments may be extended to multi-SIM multi-Standby (MSMS) and/or multi-SIM multi-active (MSMA) mobile communication devices without departing from the scope of protection.

The first communication network 190 and the second communication network 195 may be operated by the same or different service providers, and/or may support the same or different RATs, for example, but not limited to, GSM, CDMA, WCDMA, and LTE.

The user interface device 170 may include an input device 172, for example, but not limited to a keyboard, touch panel, or other human interface device, and a display device 174, for example, but not limited to, a liquid crystal display (LCD), light emitting diode (LED) display, or other video display. One of ordinary skill in the art will appreciate that other input and display devices may be used without departing from the scope of the various embodiments.

The control unit 110 may be configured to control overall operation of the mobile communication device 100 including control of the communication unit 120, the user interface device 170, and the memory 180. The control unit 110 may be a programmable device, for example, but not limited to, a microprocessor (e.g., general-purpose processor, baseband modem processor, etc.) or microcontroller.

The control unit 110 may include a timing unit 112 configured to provide one or more timers, for example, but not limited to, a voice call timer 114. Alternatively, the timing unit 112, the voice call timer 114 may be implemented as electronic circuitry separate from the control unit 110.

The memory 180 may be configured to store operating systems and/or application programs for operation of the mobile communication device 100 that are executed by the control unit 110, as well as to store application data and user data.

FIG. 1B is a diagram illustrating a network environment 105 for various embodiments. Referring to FIGS. 1A and 1B, a mobile communication device 100 may be configured to communicate with a first communication network 190 on Sub1 192 and a second communication network 195 on Sub2 197. One of ordinary skill in the art will appreciate that the mobile communication device may configured to communicate with more than two communication networks and may communicate on more than two subscriptions without departing from the scope of protection.

The first communication network 190 and the second communication network 195 may implement the same or different radio access technologies (RATs). For example, the first communication network 190 may be an LTE network and Sub1 192 may be an LTE subscription. The second communication network 195 may also be an LTE network and Sub2 197 may be an LTE subscription. Alternatively, the second communication network 195 may implement another RAT including, for example, but not limited to, GSM, CDMA, WCDMA, Time Division-Synchronous Code Division Multiple Access (TD-SCDMA), etc., and Sub2 197 may be a corresponding subscription.

The first communication network 190 may include one or more base transceiver stations (BTSs) including, for example, but not limited to, a first BTS 193. The second communication network 195 may also include one or more BTSs, including, for example, but not limited to, a second BTS 198. A person having ordinary skill in the art will appreciate that the network environment 105 may include any number of communication networks, mobile communication devices, and BTSs without departing from the scope of the various embodiments.

The mobile communication device 100 may attempt to acquire the first communication network 190 and camp on the first BTS 193. The mobile communication device 100 may also attempt to acquire the second communication network 195 and camp on the second BTS 198. A person having ordinary skill in the art will appreciate that the acquisition of the first communication network 190 performed on Sub1 192 may be independent of the acquisition of the second communication network 195 performed on Sub2 197. Furthermore, the mobile communication device 100 may attempt to acquire the first communication network 190 on Sub1 192 and the second communication network 195 on Sub2 197.

In accordance with various aspects of the disclosure, when Sub1 192 engages in a voice call (e.g., a VoLTE or circuit-switched (CS) call), Sub2 190 may relinquish control of the RF chain 135 and may maintain its current state rather than declaring a radio link failure (RLF) or out-of-service (OOS) failure. When the voice call on Sub1 192 starts, the control unit 110 may control the timing unit 112 to start the voice call timer 114.

When the voice call on Sub1 192 is completed, the control unit 110 may control the timing unit 112 to stop the voice call timer 114. Thus, the voice call timer 114 may capture the elapsed time of the voice call on Sub1 192. The elapsed time of the voice call on Sub1 192 corresponds to the time Sub2 197 did not have access to the RF chain 135 and did not communicate with the network (e.g., the second communication network 195). The elapsed time of the voice call on Sub1 192 may be stored in internal memory of the control unit 110 or may be stored in the memory 180.

The control unit 110 may check the elapsed time of the voice call on Sub1 192 (i.e., the value of the voice call timer 114) during which Sub2 197 did not have access to the RF chain 135 and determine whether to perform an RLF recovery procedure or initiate a radio resource control (RRC) connection release procedure for Sub2 197. The determination to perform an RLF recovery procedure or initiate an RRC connection release procedure for Sub2 197 may be based on a comparison of the value of the voice call timer 114 with an inactivity timer value maintained by the second communication network 195.

The second communication network 195 may maintain an inactivity timer (not shown) that may time a period during which Sub2 197 does not communicate with the second communication network 195. When the time period timed by the inactivity timer reaches a predetermined value, for example, six seconds or another value, the second communication network 195 will release the MME context for Sub2 197. As a result, any attempt to perform an RLF recovery procedure on Sub2 197 will fail. If the MME context for Sub2 197 has been released by the second communication network 195 an RRC connection release procedure may be performed on Sub2 197.

In accordance with various aspects of the present disclosure, the mobile communication device 100 may compare an elapsed time of the voice call on Sub1 192 (i.e., the value of the voice call timer 114) with the predetermined value of the inactivity timer maintained by the second communication network 195 to determine whether to perform an RLF recovery procedure or an RRC connection release procedure on Sub2 197. When the elapsed time of the voice call on Sub1 192 is greater than the predetermined value of the inactivity timer maintained by the second communication network 195 the mobile communication device 100 may perform an RRC connection release procedure on Sub2 197. For example, the control unit 110 may access the stored value of the elapsed time of the voice call on Sub1 192 and compare the elapsed time to the predetermined value of the inactivity timer.

In accordance with certain aspects of the present disclosure, the predetermined value of the inactivity timer maintained by the communication network may be obtained in various ways. For example, various network operators may provide the predetermined values of the inactivity timers for each network. In addition, individual cells within each network may have different predetermined values for inactivity timers of the individual cells. The provided predetermined values for the inactivity timers may be stored in the mobile communication device 100, for example, in a table created and stored in the memory 180 during commissioning of the mobile communication device 100.

In accordance with certain aspects of the present disclosure, the predetermined value of the inactivity timer maintained by the communication network may be indicated to the mobile communication device 100 via dedicated or broadcast signaling from the communication network (e.g., the first communication network 190 and/or the second communication network 195).

Alternatively, in accordance with certain aspects of the present disclosure, the predetermined value of the inactivity timer maintained by the communication network may be estimated by the mobile communication device 100. For example, the mobile communication device 100 may set an upper limit for an estimated inactivity timer value, e.g., 20 seconds or another value and store the estimated inactivity timer value in memory (e.g., internal memory of the control unit 110 or the memory 180). Each time a voice call ends, the mobile communication device 100 may compare the elapsed time of the voice call captured by the voice call timer 114 to the stored estimated inactivity timer value.

In response to determining that the elapsed time is greater than the estimated inactivity timer value, the mobile communication device 100 may perform an RRC connection release procedure. In response to determining that the elapsed time is not greater than the estimated inactivity timer value, the mobile communication device 100 may perform an RLF recovery procedure. In response to determining that the RLF recovery procedure is not successful, the mobile communication device 100 may store the elapsed time of the voice call as the estimated inactivity timer value and perform the RRC connection release procedure.

In response to determining that the RLF recovery procedure is successful, the mobile communication device 100 may store the elapsed time of the voice call as the estimated inactivity timer value and perform the RLF recovery procedure anytime the elapsed time of a voice call is not greater than the estimated inactivity timer value. The mobile communication device 100 may perform the RRC connection release procedure anytime the elapsed time of a voice call is greater than the estimated inactivity timer value.

In response to determining that the elapsed time is not greater than the predetermined value of the inactivity timer, the control unit 110 may control the communication unit 120 to perform an RLF recovery procedure on Sub2 197. In response to determining that the elapsed time is greater than the predetermined value of the inactivity timer, the control unit 110 may control the communication unit 120 to perform an RRC connection release procedure on Sub2 197.

In accordance with certain aspects of the present disclosure, in response to determining that the elapsed time is greater than the estimated inactivity timer value, the mobile communication device 100 may perform an RRC connection release procedure on Sub2 197. The RRC connection release procedure on Sub2 197 may include targeted network acquisition based on the physical cell identification (PCI) and frequency of Sub1 192 when both Sub1 192 and Sub2 197 communicate on the same public land mobile network (PLMN) or roaming partners of the same PLMN. The targeted acquisition may result in faster RRC connection establishment on Sub2 197.

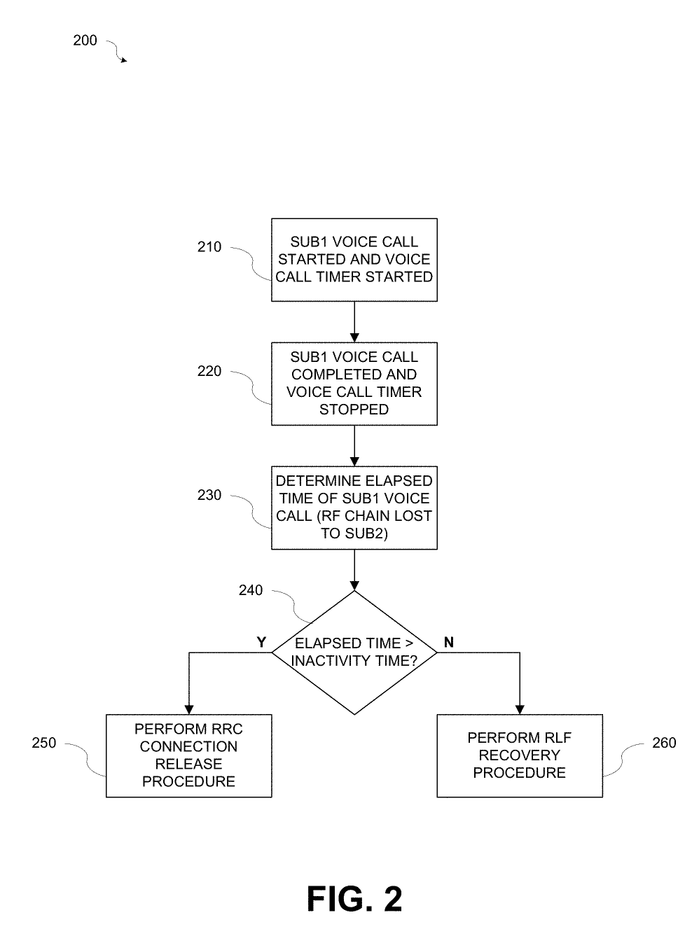

FIG. 2 is a flowchart illustrating a method 200 for reestablishing an RRC connection on a second subscription after a voice call on a first subscription for an MSMS mobile communication device in accordance with various aspects of the present disclosure. Referring to FIG. 2, at block 210 a voice call may be started on Sub1 192 and the voice call timer 114 started. For example, the control unit 110 may control the communication unit 120 to place or receive a voice call on Sub1 192 with a communication network (e.g., the first communication network 190). At the same time, the control unit 110 may control the timing unit 112 to start the voice call timer 114. Sub1 192 will control the RF chain 135 during the time Sub1 192 is engaged in the voice call such that the RF chain 135 will not be available for Sub2 197 to communicate with the communication network (e.g., the second communication network 195).

At block 220, the control unit 110 may control the communication unit 120 to end the voice call on Sub1 192. At the same time, the control unit 110 may control the timing unit 112 to stop the voice call timer 114. At block 230, the control unit 110 may determine the elapsed time of the Sub1 192 voice call. The elapsed time of the Sub1 192 voice call may correspond to the length of time that the RF chain 135 was not available to Sub2 197.

At block 240, the mobile communication device 100 may determine whether the elapsed time of the Sub1 192 voice call is greater than the predetermined value of the inactivity timer for the communication network (e.g., the second communication network 195). The predetermined value of the inactivity timer for the second communication network 195 may be provided by the network operator and previously stored in the mobile communication device (e.g., in internal memory of the control unit 110 or in the memory 180), may be previously broadcast to the mobile communication device 100 via dedicated or broadcast signaling, or maybe estimated by the mobile communication device 100.

In response to determining that the elapsed time of the voice call on Sub1 192 is greater than the predetermined value of the inactivity timer (240-Y), at block 250 the mobile communication device 100 may perform an RRC connection release procedure on Sub2 197. For example, the control unit 110 may control the communication unit 120 to perform the RRC connection release procedure on Sub2 197.

In response to determining that the elapsed time of the voice call on Sub1 192 is not greater than the predetermined value of the inactivity timer (240-N), at block 260 the mobile communication device 100 may perform an RLF recovery procedure on Sub2 197. For example, the control unit 110 may control the communication unit 120 to perform the RLF recovery procedure on Sub2 197.

Since the RLF recovery procedure on Sub2 197 will fail if the elapsed time of the voice call on Sub1 192 is greater than the predetermined value of the inactivity timer, aspects of the present disclosure may provide faster reconnection for Sub2 197 by avoiding RLF recovery procedure attempts when the elapsed time of the voice call on Sub1 192 is greater than the predetermined value of the inactivity timer.

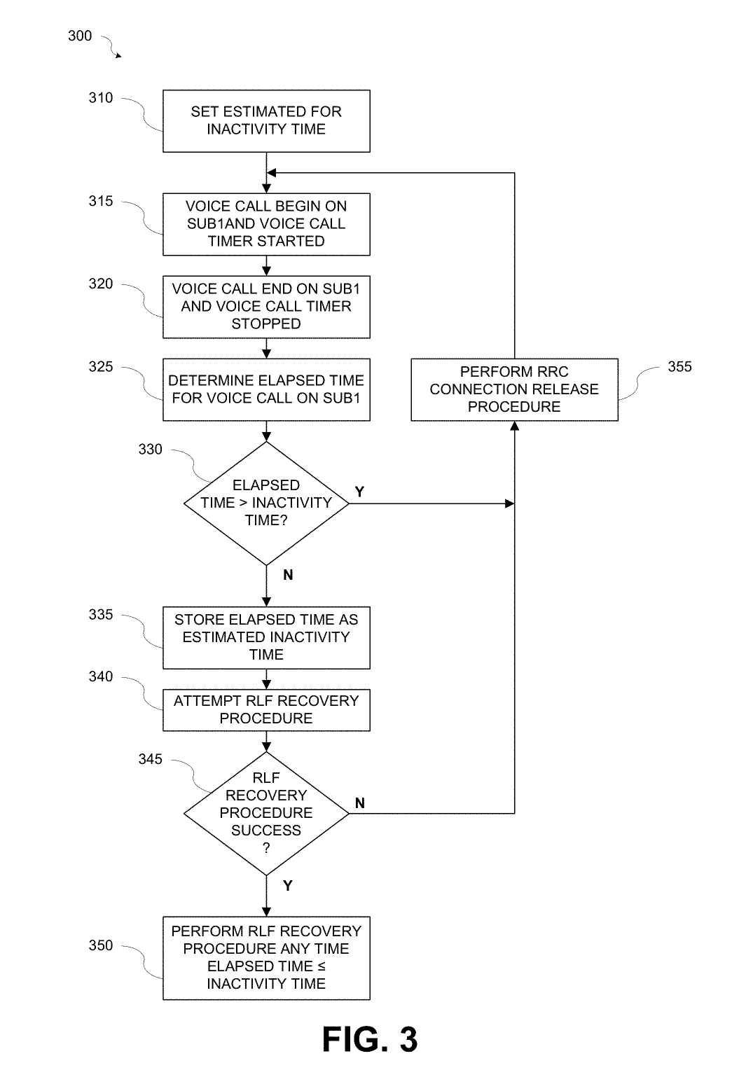

FIG. 3 is a flowchart illustrating a method 300 for estimating the value of the inactivity time in accordance with various aspects of the present disclosure. Referring to FIG. 3, at block 310 an estimated value for the inactivity time may be set. For example, the control unit 110 may control the timing unit 112 to set an upper limit for the inactivity time that is greater than known network connectivity timer values as the estimated value for the inactivity time. The estimated value for the inactivity time may be stored, for example, in internal memory of the control unit 110 or in the memory 180.

At block 315, a voice call may begin on Sub1 192 and the voice call timer 114 may be started. For example, the control unit 110 may control the communication unit 120 to receive a voice call on Sub1 192. The control unit 110 may control the communication unit 120 to grant control of the RF chain 135 to Sub1 192. Accordingly, Sub2 197 may not access the RF chain 135. The control unit 110 may also control the timing unit 112 to start the voice call timer 114.

At block 320, the voice call on Sub1 192 may end and the voice call timer 114 may be stopped. For example, the control unit 110 may control the communication unit 120 to end the voice call on Sub1 192 and release the RF chain 135 from Sub1 192 and grant control of the RF chain 135 to Sub2 197. The control unit 110 may also control the timing unit 112 to stop the voice call timer 114. The control unit 110 may cause the elapsed time value from the voice call timer 114 to be stored, for example, in internal memory of the control unit 110 or in the memory 180.

At block 325, the control unit 110 may determine the elapsed time for the voice call on Sub1 192. For example, the control unit 110 may access the stored elapsed time value of the voice call timer 114 from the internal memory of the control unit 110 or the memory 180. At block 330, the control unit 110 may determine whether the elapsed time is greater than the estimated value for the inactivity time. For example, the control unit may determine whether the elapsed time value of the voice call timer 114 is greater than the stored estimated value for the inactivity time. For example, the control unit 110 may access the stored estimated value for the inactivity time and compare the elapsed time with the estimated value for the inactivity time.

In response to determining that the elapsed time of the voice call on Sub1 192 is greater than the estimated value for the inactivity time (330-Y), at block 355 an RRC connection release procedure may be performed on Sub2 197 and the process may continue at block 315 when a voice call begins on Sub1 192. For example, the control unit 110 may control the communication unit 120 to perform an RRC connection release procedure on Sub2 197 the communication network (e.g., the second communication network 195). Since the elapsed time of the voice call on Sub1 192 is greater than the estimated value for the inactivity time the communication network will have released the MME context for Sub2 197 and an RLF recovery procedure attempt would fail. Therefore, time is not wasted by attempting the RLF recovery procedure.

In response to determining that the elapsed time of the voice call on Sub1 192 is not greater than the estimated value for the inactivity time (330-N), at block 335 the control unit 110 may store the elapsed time of the voice call on Sub1 192 as the estimated inactivity time. For example, the control unit 110 may store the elapsed time of the voice call on Sub1 192 in the internal memory of the control unit 110 or the memory 180 as the estimated value for the inactivity time.

At block 340, an RLF recovery procedure may be attempted. For example, the control unit 110 may control the communication unit 120 to attempt an RLF recovery procedure for Sub2 197. At block 345, it may be determined whether the RLF recovery procedure was successful. For example, the control unit 110 may control the communication unit 120 to attempt an RLF recovery procedure for Sub2 197 with the communication network (e.g., the second communication network 195). Since the elapsed time of the voice call on Sub1 192 was less than the previous estimated value of the inactivity time, the RLF recovery procedure may be successful.

In response to determining that the RLF recovery procedure was not successful (345-N), at block 355 an RRC connection release procedure may be performed on Sub2 197 and the process may continue at block 315 when a voice call begins on Sub1 192. In response to determining that the RLF recovery procedure was successful (345-Y), at block 350 and RLF recovery procedure may be attempted on Sub2 197 anytime the elapsed time of a voice call on Sub1 192 is less than or equal to the stored estimated inactivity time. For example, when the control unit 110 determines that the elapsed time of a voice call on Sub1 192 is less than or equal to the stored estimated inactivity time the control unit 110 may control the communication unit 120 to attempt an RLF recovery procedure on Sub2 197 with the communication network (e.g., the second communication network 195).

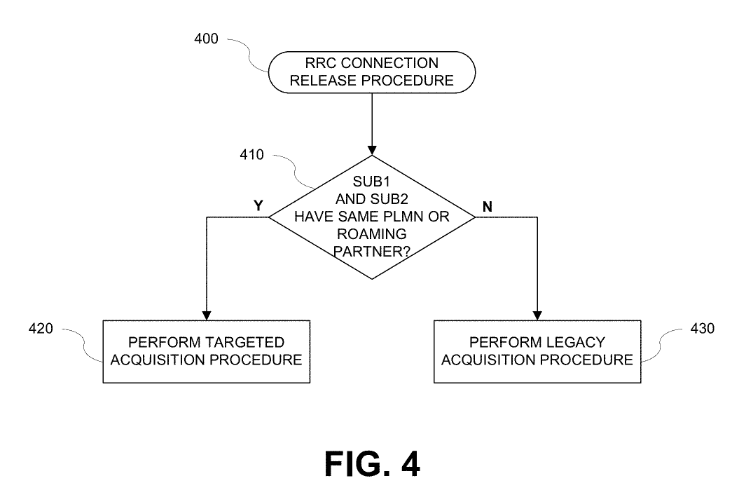

FIG. 4 is a flowchart illustrating a method 400 for performing an RRC connection release procedure in accordance with various aspects of the present disclosure. Referring to FIG. 4, at block 410 it may be determined whether Sub1 192 and Sub2 197 communicate with a same PLMN or roaming partner of the same PLMN. In response to determining that Sub1 192 and Sub2 197 do not communicate with the same PLMN or roaming partner of the same PLMN (410-N), at block 430 the control unit 110 may control the communication unit 120 to perform a legacy network acquisition procedure.

In response to determining that Sub1 192 and Sub2 197 do communicate with the same PLMN or roaming partner of the same PLMN (410-Y), at block 420 the control unit 110 may control the communication unit 120 to perform a targeted network acquisition procedure on Sub2 197. The RRC connection release procedure on Sub2 197 may include targeted network acquisition based on the physical cell identification (PCI) and frequency of Sub1 192 when both Sub1 192 and Sub2 197 communicate on the same public land mobile network (PLMN) or roaming partners of the same PLMN. For example, the control unit 110 may control the communication unit 120 to perform an RRC connection procedure on Sub2 197 with a communication network (e.g., the second communication network 195) using the PCI and frequency used by Sub1 192. The targeted acquisition may result in faster RRC connection establishment on Sub2 197.

While the above methods have been described in terms of a voice call on Sub1 one of ordinary skill in the art will appreciate that a voice call may be received on Sub2 and corresponding operations performed without departing from the scope of the present disclosure.

The methods 200, 300, and 400, respectively, may be embodied on a non-transitory computer readable medium, for example, but not limited to, the memory 180 or other non-transitory computer readable medium known to those of skill in the art, having stored therein a program including computer executable instructions for making a processor, computer, or other programmable device execute the operations of the methods.

The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The accompanying claims and their equivalents are intended to cover such forms or modifications as would fall within the scope and spirit of the protection. For example, the example apparatuses, methods, and systems disclosed herein can be applied to multi-SIM wireless devices subscribing to multiple communication networks and/or communication technologies. The various components illustrated in the figures may be implemented as, for example, but not limited to, software and/or firmware on a processor, ASIC/FPGA/DSP, or dedicated hardware. Also, the features and attributes of the specific example embodiments disclosed above may be combined in different ways to form additional embodiments, all of which fall within the scope of the present disclosure.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc., are not intended to limit the order of the operations; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the various embodiments.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A method for reestablishing a radio resource control (RRC) connection on a second subscription upon completion of a voice call on a first subscription for a multi-subscriber identity module (SIM) multi-standby (MSMS) mobile communication device, the method comprising:
starting a voice call timer at the start of the voice call on the first subscription;
stopping the voice call timer upon completion of the voice call on the first subscription;
determining an elapsed time of the voice call on the first subscription based on a value of the voice call timer; and
determining whether the elapsed time of the voice call on the first subscription is greater than a value of a network connectivity timer.

2. The method of claim 1, further comprising:
in response to determining that the elapsed time of the voice call on the first subscription is not greater than the value of the network connectivity timer, performing a radio link failure (RLF) recovery procedure on the second subscription.

3. The method of claim 1, further comprising:
in response to determining that the elapsed time of the voice call on the first subscription is greater than the value of the network connectivity timer, performing a radio resource control (RRC) connection release procedure on the second subscription.

4. The method of claim 3, further comprising:
determining whether the first subscription and the second subscription communicate on a same public land mobile network (PLMN) or a roaming partner of the same PLMN; and
in response to determining that the first subscription and the second subscription communicate on the same PLMN or a roaming partner of the same PLMN, performing a targeted acquisition procedure.

5. The method of claim 4, wherein the targeted acquisition procedure comprises:
performing an RRC connection procedure on the second subscription using the physical cell identification (PCI) and frequency used by the first subscription.

6. The method of claim 1, further comprising:
determining the value of the network connectivity timer from one or more predetermined network connectivity timer values stored in a memory of the MSMS mobile communication device.

7. The method of claim 1, further comprising:
determining the value of the network connectivity timer via dedicated or broadcast signaling received from a communication network.

8. The method of claim 1, further comprising:
determining the value of the network connectivity timer by estimating the value of the network connectivity timer.

9. The method of claim 8, wherein the estimating the value of the network connectivity timer comprises:
setting an upper limit for an estimated value for the inactivity time;
determining if the elapsed time of the voice call on the first subscription is greater than the estimated value for the inactivity time; and
in response to determining that the elapsed time of the voice call on the first subscription is not greater than the estimated value for the inactivity time, storing the elapsed time of the voice call on the first subscription as the estimated value for the inactivity time.

10. A multi-subscriber identity module (SIM) multi-standby (MSMS) mobile communication device, comprising:
a communication unit configured to communicate with one or more communication networks;
a memory operably connected to the communication unit;
a timing unit configured to implement one or more timers; and
a control unit operably connected to the communication unit, the memory, and the timing unit, the control unit configured to:
control the timing unit to start a voice call timer at the start of a voice call on a first subscription;
control the timing unit to stop the voice call timer upon completion of the voice call on the first subscription;
determine an elapsed time of the voice call on the first subscription based on a value of the voice call timer; and
determine whether the elapsed time of the voice call on the first subscription is greater than a value of a network connectivity timer.

11. The MSMS mobile communication device of claim 10, wherein the control unit is further configured to:
in response to determining that the elapsed time of the voice call on the first subscription is not greater than the value of the network connectivity timer, control the communication unit to perform a radio link failure (RLF) recovery procedure on the second subscription.

12. The MSMS mobile communication device of claim 10, wherein the control unit is further configured to:
in response to determining that the elapsed time of the voice call on the first subscription is greater than the value of the network connectivity timer, control the communication unit to perform a radio resource control (RRC) connection release procedure on the second subscription.

13. The MSMS mobile communication device of claim 12, wherein the control unit is further configured to:
determine whether the first subscription and the second subscription communicate on a same public land mobile network (PLMN) or a roaming partner of the same PLMN; and
in response to determining that the first subscription and the second subscription communicate on the same PLMN or a roaming partner of the same PLMN, control the communication unit to perform a targeted acquisition procedure.

14. The MSMS mobile communication device of claim 13, wherein the targeted acquisition procedure comprises:
controlling the communication unit to perform an RRC connection procedure on the second subscription using the physical cell identification (PCI) and frequency used by the first subscription.

15. The MSMS mobile communication device of claim 10, wherein the control unit is further configured to:
determine the value of the network connectivity timer from one or more predetermined network connectivity timer values stored in the memory of the MSMS mobile communication device.

16. The MSMS mobile communication device of claim 10, wherein the control unit is further configured to:
control the communication unit to receive dedicated or broadcast signaling received from a communication network; and
determine the value of the network connectivity timer via the dedicated or broadcast signaling.

17. The MSMS mobile communication device of claim 10, wherein the control unit is further configured to:
determine the value of the network connectivity timer by estimating the value of the network connectivity timer.

18. The MSMS mobile communication device of claim 17, wherein the control unit is further configured to estimate the value of the network connectivity timer by:
accessing an upper limit for an estimated value for the inactivity time from the memory;
determining if the elapsed time of the voice call on the first subscription is greater than the estimated value for the inactivity time; and
in response to determining that the elapsed time of the voice call on the first subscription is not greater than the estimated value for the inactivity time, storing the elapsed time of the voice call on the first subscription as the estimated value for the inactivity time.

19. A non-transitory computer readable medium having stored thereon instructions for causing one or more processors to perform a method for reestablishing a radio resource control (RRC) connection on a second subscription upon completion of a voice call on a first subscription for a multi-subscriber identity module (SIM) multi-standby (MSMS) mobile communication device, the instructions including operations comprising:
starting a voice call timer at the start of the voice call on the first subscription;
stopping the voice call timer upon completion of the voice call on the first subscription;
determining an elapsed time of the voice call on the first subscription based on a value of the voice call timer; and
determining whether the elapsed time of the voice call on the first subscription is greater than a value of a network connectivity timer.

20. The non-transitory computer readable medium as defined in claim 19, further comprising instructions to perform operations comprising:
in response to determining that the elapsed time of the voice call on the first subscription is not greater than the value of the network connectivity timer, performing a radio link failure (RLF) recovery procedure on the second subscription.

21. The non-transitory computer readable medium as defined in claim 19, further comprising instructions to perform operations comprising:
in response to determining that the elapsed time of the voice call on the first subscription is greater than the value of the network connectivity timer, performing a radio resource control (RRC) connection release procedure on the second subscription.

22. The non-transitory computer readable medium as defined in claim 21, further comprising instructions to perform operations comprising:
determining whether the first subscription and the second subscription communicate on a same public land mobile network (PLMN) or a roaming partner of the same PLMN; and
in response to determining that the first subscription and the second subscription communicate on the same PLMN or a roaming partner of the same PLMN, performing a targeted acquisition procedure.

23. The non-transitory computer readable medium as defined in claim 22, further comprising instructions to perform operations comprising:
performing an RRC connection procedure on the second subscription using the physical cell identification (PCI) and frequency used by the first subscription.

24. The non-transitory computer readable medium as defined in claim 19, further comprising instructions to perform operations comprising:
determining the value of the network connectivity timer from one or more predetermined network connectivity timer values stored in a memory of the MSMS mobile communication device.

25. The non-transitory computer readable medium as defined in claim 19, further comprising instructions to perform operations comprising:
determining the value of the network connectivity timer via dedicated or broadcast signaling received from a communication network.

26. The non-transitory computer readable medium as defined in claim 19, further comprising instructions to perform operations comprising:
determining the value of the network connectivity timer by estimating the value of the network connectivity timer.

27. The non-transitory computer readable medium as defined in claim 26, further comprising instructions to perform operations comprising:
setting an upper limit for an estimated value for the inactivity time;
determining if the elapsed time of the voice call on the first subscription is greater than the estimated value for the inactivity time; and
in response to determining that the elapsed time of the voice call on the first subscription is not greater than the estimated value for the inactivity time, storing the elapsed time of the voice call on the first subscription as the estimated value for the inactivity time.

28. A multi-subscriber identity module (SIM) multi-standby (MSMS) mobile communication device, comprising:
means for starting a voice call timer at the start of a voice call on a first subscription;
means for stopping the voice call timer upon completion of the voice call on the first subscription;
means for determining an elapsed time of the voice call on the first subscription based on a value of the voice call timer; and
means for determining whether the elapsed time of the voice call on the first subscription is greater than a value of a network connectivity timer.

29. The MSMS mobile communication device of claim 28, further comprising:
in response to determining that the elapsed time of the voice call on the first subscription is not greater than the value of the network connectivity timer, means for performing a radio link failure (RLF) recovery procedure on a second subscription.

30. The MSMS mobile communication device of claim 28, further comprising:
in response to determining that the elapsed time of the voice call on the first subscription is greater than the value of the network connectivity timer, means for performing a radio resource control (RRC) connection release procedure on the second subscription.
